(19) United States
(12) Patent Application Publication
(10) Pub. No.: US 2010/0079380 A1
(43) Pub. Date: Apr. 1, 2010

(54) INTELLIGENT INPUT DEVICE LOCK

(75) Inventor: Mikko Nurmi, Tampere (FI)

Correspondence Address: Perman & Green, LLP, 99 Hawley Lane, Stratford, CT, 06614, US

(73) Assignee: Nokia Corporation, Espoo (FI)

(21) Appl. No.: 12/241,585

(22) Filed: Sep. 30, 2008

(51) Int. Cl. G06F 3/02; G06F 3/041

(52) U.S. Cl. 345/172; 345/173

(57) ABSTRACT

A method including selecting one or more keys on an apparatus where selecting the one or more keys unlocks an input device of the apparatus and activates an application of the apparatus substantially at the same time.

### BACKGROUND

1. Field

The aspects of the disclosed embodiments generally relate to input feature locks for a device and more particularly to unlocking the input features of the device.

2. Brief Description of Related Developments

Generally users of devices, such as for example portable communication devices, lock the keys or other input feature of the device to prevent inadvertent or unintended use of the device. As a non-limiting example, keys or touch screens of a portable communication device, which has been placed in a pocket of a user, may be activated such that a telephone call is made inadvertently without the knowledge of the user. Locking the keys and/or touch screen will generally prevent such a telephone call from being made.

To unlock, for example, the keys and/or touch screen of the device so that functions and applications of the device can be accessed, the user generally presses or otherwise activates a series of keys. This series of keys is generally activated in some predetermined sequence to prevent an unintentional unlocking of the keys. On a touch screen device, unlocking the touch screen may be performed by creating a predetermined gesture or movement on the touch screen. For example, to access an application of the device, the user generally must first unlock the device by activating the series of keys or creating a gesture on the touch screen. After unlocking the keys, the user has to launch a desired application and after the application is launched the user has to select a desired feature of the launched application. As a non-limiting example, the desired application may be a messaging application and the desired feature of the launched application may be the creation of a new message.

It would be advantageous to be able to access application features in an easy and efficient manner as the device is unlocked.

### SUMMARY

In one aspect of the disclosed embodiments, a method is provided. The method includes selecting one or more keys on an apparatus where selecting the one or more keys unlocks an input device of the apparatus and activates an application of the apparatus substantially at the same time.

In another aspect of the disclosed embodiments, an apparatus and a user interface are provided. The apparatus and user interface generally include an input device having at least one key corresponding to a respective application of the apparatus, and a processor connected to the input device, the processor being configured to, detect a selection of the at least one key, unlock the input device in response to the detected selection, and activate a respective application corresponding to the selected at least one key, wherein the input device is unlocked substantially simultaneously with the activation of the respective application.

In yet another aspect of the disclosed embodiments, a computer useable medium is provided. The computer useable medium includes computer readable code means embodied therein for causing a computer to unlock an input device and activate an application of the computer. The computer readable code means in the computer useable medium includes computer readable program code means for causing a computer to detect a selection of one or more keys on an input device of the computer, and computer readable program code means for causing a computer to unlock the input device and activate an application of the apparatus substantially at the same time in response to detecting the selection of the one or more keys.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2, 3A and 3B illustrate exemplary screen shots in accordance with aspects of the disclosed embodiments;

FIG. 4 is an exemplary flow chart illustrating an operation in accordance with aspects of the disclosed embodiments;

FIGS. 5A and 5B are illustrations of exemplary devices that can be used to practice aspects of the disclosed embodiments;

FIG. 6 illustrates a block diagram of an exemplary system incorporating features that may be used to practice aspects of the disclosed embodiments; and

FIG. 7 is a block diagram illustrating the general architecture of an exemplary system in which the devices of FIGS. 5A and 5B may be used.

### DETAILED DESCRIPTION OF THE EMBODIMENT(S)

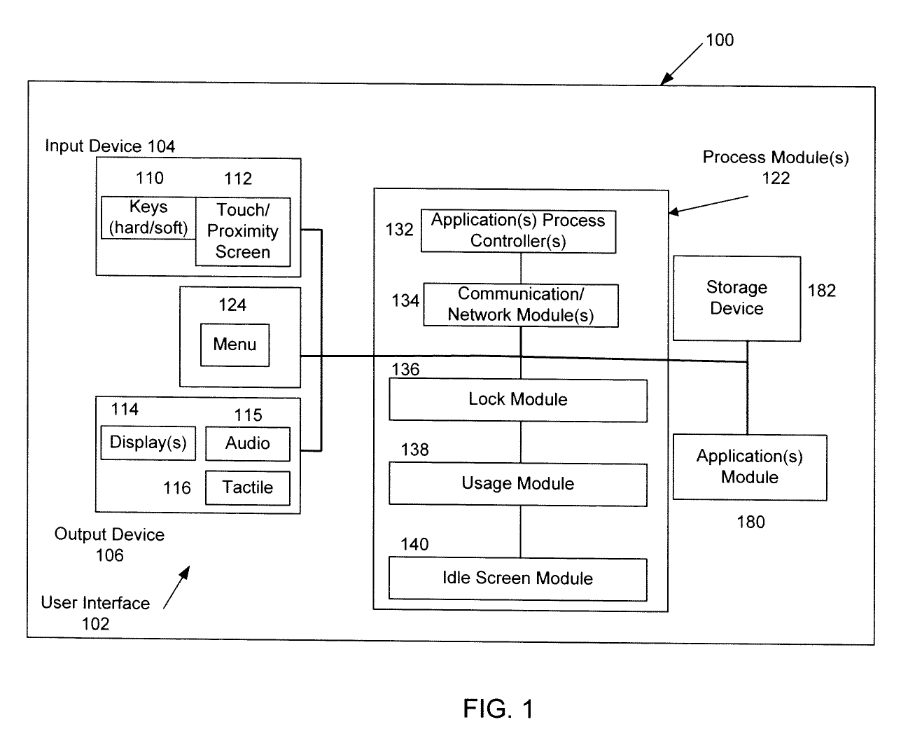

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

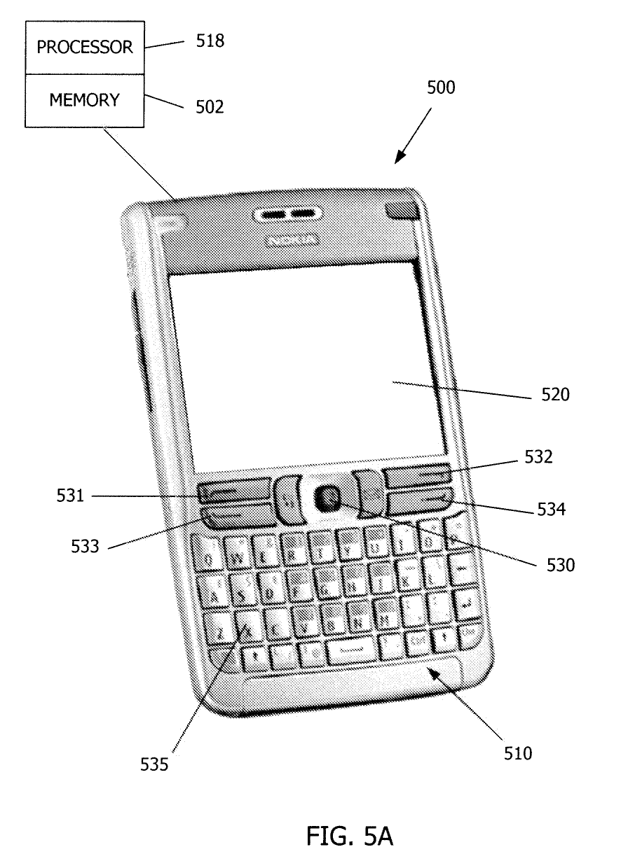

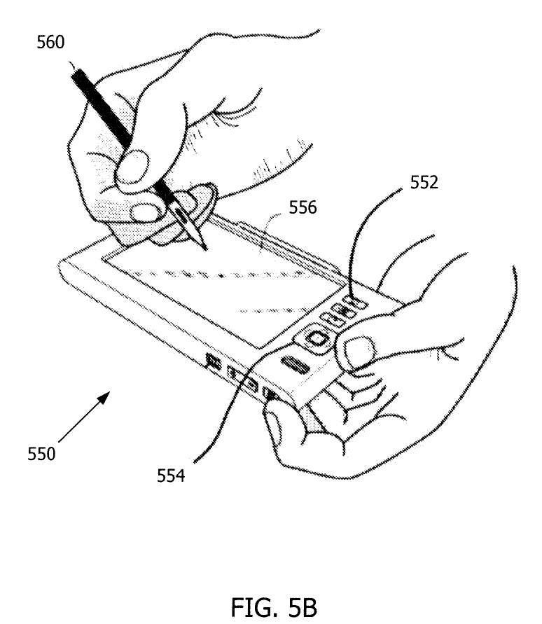

The aspects of the disclosed embodiments generally allow a user to access features of a device application while unlocking the system 100. The term “unlock” as used herein is generally the re-enabling of an input device 104 that was previously disabled or “locked” for preventing unintended use of the system 100. As a non-limiting example, in one aspect, the input device 104 of the system 100 may be unlocked by selecting two or more keys 110 (e.g. hard “physical” keys or soft “virtual” keys) in a predetermined sequence or simultaneously. In another aspect, the input device 104 may be unlocked by selecting a single key. In accordance with an aspect of the disclosed embodiments, a functionality of the system 100 is linked with the unlocking of the input device 104. For example, the keys 110 for unlocking the system 100 correspond to applications and features of the applications. The applications may include any suitable applications including, but not limited to, calendars, maps, cameras, messaging, email, word processors, spreadsheets, notes, games, phone/address books, calls, music players and video players. The features of the application(s), which will be referred to herein as “application sub-parts” may include, as non-limiting examples, new, open, view and search or any other features of the a respective application that are generally accessible to a user after the respective application has been activated or launched. One or more applications and one or more application sub-parts may be, for example, presented on a display 114 as soft keys of the system 100 when the system 100 is an in idle mode (e.g. the application(s) and application sub-parts are presented on an idle screen). The idle mode may be a state of the system 100 when, for example, the system 100 is not being actively used. In other examples, the applications and application sub-parts may correspond to and be presented along with hard keys of the 114 of the system (see e.g. keys 535 in FIG. 5A). In accordance with an aspect of the disclosed embodiments, when unlocking the device an application and/or sub-part may be selected such that the selection of the application and/or sub-part unlocks the input device 104 and causes an activation of an appropriate feature of the selected application as will be described in greater detail below. It is noted that in one aspect of the disclosed embodiments one or more of the application sub-parts presented on the idle screen may be applied to more than one application (e.g. the application sub-part may be a common application sub-part). For example, a “new” application sub-part may apply to both a messaging and a spreadsheet application such that when activated along with the messaging or spreadsheet applications new messages and new spreadsheets are respectively created.

Referring to FIG. 1, the system 100 of the disclosed embodiments can generally include input device(s) 104, output device(s) 106, process module 122, applications module 180, and storage/memory device(s) 182. The components described herein are merely exemplary and are not intended to encompass all components that can be included in the system 100. The system 100 can also include one or more processors or computer program products/computer useable media to execute the processes, methods, sequences, algorithms and instructions described herein.

The input device(s) 104 are generally configured for allowing a user to input data, instructions and commands to the system 100. In one embodiment, the input device 104 can be configured to receive input commands remotely or from another device that is not local to the system 100. The input device 104 can include devices such as, for example, keys 110, touch screen 112 and menu 124. In alternate embodiments the input device 104 can comprise any suitable device(s) or means that allows or provides for the input of data, information and/or instructions to a device, as described herein.

The output device(s) 106 are configured to allow information and data to be presented via the user interface 102 of the system 100 and can include one or more devices such as, for example, a display 114 (which can be part of or include the touch screen 112), audio device 115 or tactile output device 116. In one embodiment, the output device 106 can be configured to transmit information to another device, which can be remote from the system 100. While the input device 104 and output device 106 are shown as separate devices, in one embodiment, the input device 104 and output device 106 can be combined into a single device, and be part of and form, the user interface 102. The user interface 102 of the disclosed embodiments can be generally configured to allow a user to launch or otherwise activate a predetermined feature of an application while unlocking the input device 104 of the system 100. While certain devices are shown in FIG. 1, the scope of the disclosed embodiments is not limited by any one or more of these devices, and an exemplary embodiment can include additional devices or exclude one or more of the devices shown. For example, in one exemplary embodiment, the system 100 may only provide a touch screen 112 capable of presenting one or more soft keys in the form of, for example, graphical or textual icons representing applications or application sub-parts (e.g. the system 100 does not include any hard or dedicated keys). In other examples, a headset, or other listening device, can be used as part of both the input devices 104 and output devices 106 and be configured to allow unlocking of the input device 104.

The process module 122 is generally configured to execute the processes and methods of the disclosed embodiments. The application process controller 132 can be configured to interface with the applications module 180, for example, and execute applications processes with respect to the other modules of the system 100. In one embodiment, the applications module 180 is configured to interface with applications that are stored either locally to or remote from the system 100 and/or web-based applications. The applications module 180 can include any one of a variety of applications that may be installed, configured or accessed by the system 100, such as for example, those applications and application sub-parts described above. In alternate embodiments, the applications module 180 can include any suitable application(s). The communication module 134 shown in FIG. 1 is generally configured to allow the device to receive and send communications and messages, such as text messages, chat messages, multimedia messages, video and email, for example. The communication module 134 is also configured to receive information, data and communications from other devices and systems.

In one aspect of the disclosed embodiments, the process module 122 includes a lock module 136 and an idle screen module 140. It is noted that the lock module 136 and/or the idle screen module 140 may be integral with the process module 122. In alternate embodiments, the lock module 136 and or the idle screen module 140 may be separate from the process module 122. The lock module 136 is configured to allow for locking or otherwise disabling the input device 104 of the system 100 to, for example, prevent an unintended use of the system 100. The input device 104 may be locked in any suitable manner. The lock module 136 may also be configured to allow activation of an application and/or a feature of an application (e.g. the application sub-part) when an unlocking of the input device 104 occurs as will be described below.

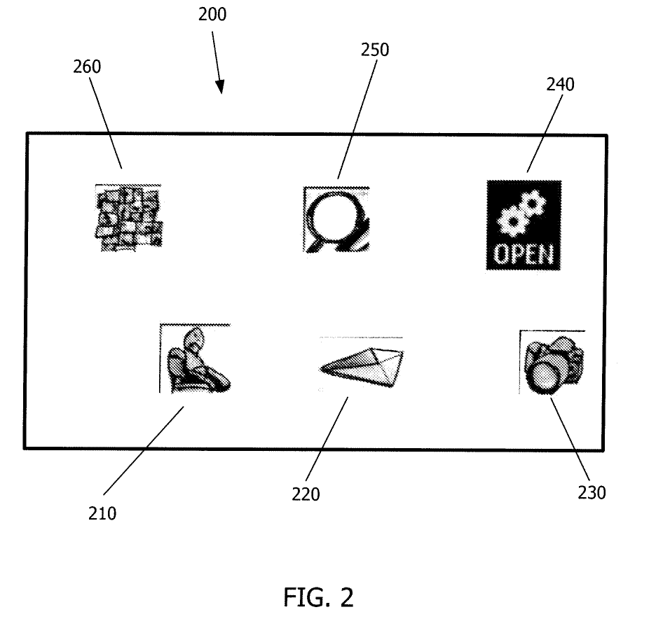

The idle screen module 140 may be configured to present predetermined applications and/or application sub-parts on the display 114 when the system 100 is in an idle mode (e.g. not being actively used). The contents of the idle screen may be any suitable content including, for example, links or graphical icons corresponding to the exemplary applications and/or application sub-parts described herein. Referring to FIG. 2, one example, of an idle screen 200 presented on display 114 is shown in accordance with an aspect of the disclosed embodiments. In this example, the contents of the idle screen 200 include graphical icons 210-260 corresponding to applications and application sub-parts of the system 100. For example, icon 210 may correspond to a phone book, icon 220 may correspond to a messaging application, icon 230 may correspond to a camera application and icon 260 may correspond to a photo album application. Icons 240, 250 may correspond to application sub-parts. Icon 240 may correspond to an “open” feature of the applications such that when selected along with one or more of the applications 210-230, 260 the application(s) is launched or activated and an open feature of the application is presented. For example, if the open icon 240 is selected along with the photo album icon 260 the photo album is launched and a list of photos are presented for selection by a user. Selection of the photo will open the photo for viewing on, for example, the display 114. In another example, icon 250 may correspond to a “search” feature of the applications such that when selected along with one or more of the application icons 210-230, 260 the corresponding application(s) is launched and a search feature of the application is presented. For example, when the search icon 250 is selected along with the phone book icon 210, a phone book application is launched and a search feature of the phone book application is presented to the user. It should be understood that the applications and application sub-parts shown in FIG. 2 are for exemplary purposes only and that any suitable applications and/or subparts may be presented on the idle screen 200. It should also be understood that the applications and application sub-parts presented in the idle screen 200 may be selected in any suitable combinations and that the examples provided above with respect to FIG. 2 are for illustrative purposes only.

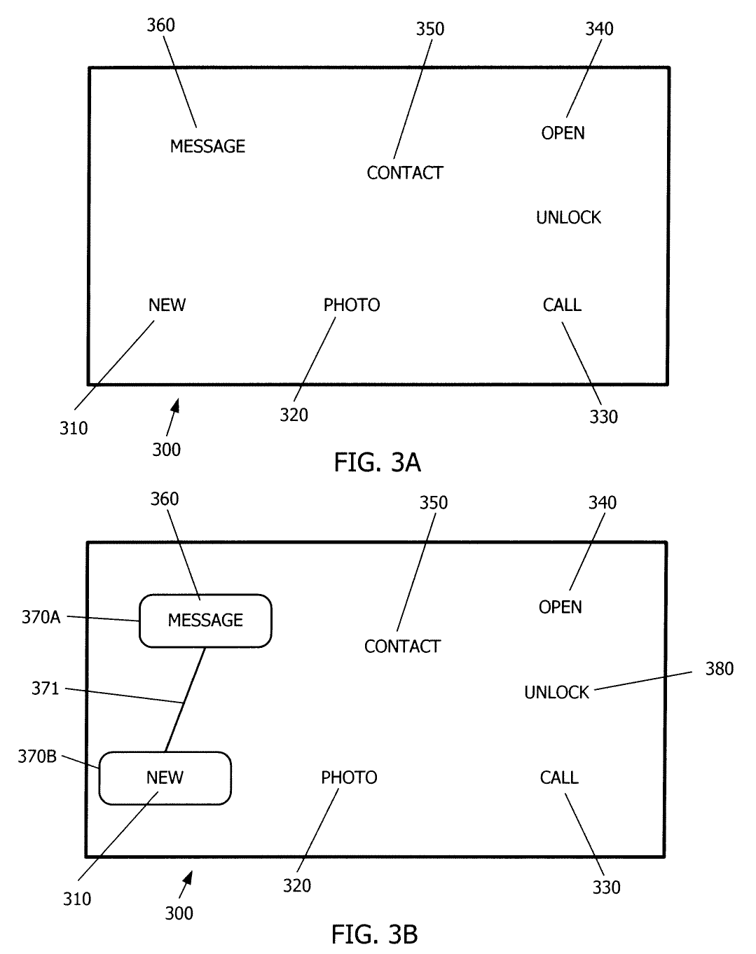

Referring to FIG. 3A, another exemplary idle screen 300 is shown in accordance with an aspect of the disclosed embodiments. The idle screen 300 may be substantially similar to idle screen 200 described above. However, in this example, the idle screen includes textual icons 310-360 corresponding to applications and application sub-parts of the system 100. In this example, the message icon 360, photo icon 320 and contact icon 350 may correspond respectively to messaging, camera and phone book applications of the system 100. The new icon 310, call icon 330 and open icon 340 may correspond to application sub-parts of the system 100. As a non-limiting example of an operation of the icons 310-360, when the new icon 310 is selected along with, for example, the message icon 360 the message application is launched and a new message is opened.

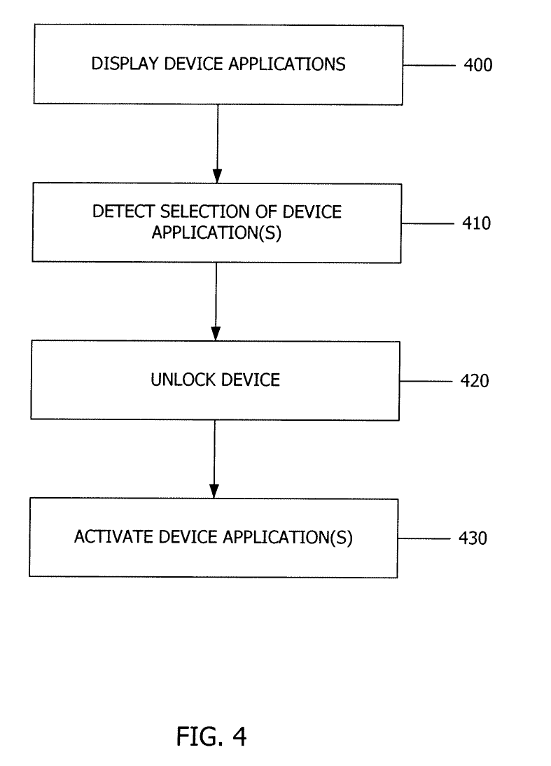

Referring to FIGS. 1, 3B and 4 an operation in accordance with an aspect of the disclosed embodiments will be described. As can be seen in FIG. 3B applications and application sub-parts are presented on the display in, for example, the idle screen 300 (FIG. 4, Block 400). In one aspect the system 100 is unlocked by selecting a combination of the application icons and application sub-parts icons 310-360 from, for example, a touch enable screen such as touch screen 112. It should be understood that while the exemplary operation is described herein with respect to a touch screen, in alternate embodiments the exemplary operation can be equally applied to hard keys of a device. In this example, the process module 122 (which in this example includes the lock module 136) is configured to detect a selection of one or more of the icons 310-360 corresponding to the applications and application sub-parts (FIG. 4, Block 410). For example, as can be seen in FIG. 3B the process module 122 detects selection of the message icon 360 and the new icon 310. The icons 360, 310 may be selected in any suitable manner such as by, touching an area of the touch screen 112 on which the icons are displayed or by selecting a corresponding key of the device. The icons 360, 310 may be selected in sequence (e.g. one after the other on, for example, a single-touch enable screen) or simultaneously (e.g. on for example a multi-touch enabled screen). As such, the process module 122 is configured to detect the sequential selection or simultaneous selection of the icons 360, 310. In one example, the process module 122 may also be configured to highlight or otherwise indicate which icons or combination of icons are selected. For example, a border 370A, 370B or other indicator (e.g. changes in icon color, background, etc.) may be placed substantially around the respective icons 360, 310 to indicate the icons are selected. In another example, a connecting line 371 may be placed between two or more selected icons to indicate that the applications and/or application sub-parts corresponding thereto are to be launched or otherwise activated together. In alternate embodiments, the detected selection of the icons may be indicated in any suitable manner.

In this example, upon detection of a selection of two or more icons corresponding to applications and/or application sub-parts the touch screen 112 and/or other input devices of the system 100 are unlocked (FIG. 4, Block 420). In one aspect, unlocking of the input device(s) 104 is performed through a detection of selecting a predetermined number of the applications and/or application sub-parts. In this example, the input device 104 is unlocked when a selection of two of the icons presented in the idle screen 300 is detected. For exemplary purposes only, one icon corresponding to an application and one icon corresponding to an application sub-part are selected for unlocking the input device 104. In alternate embodiments the system may be configured to unlock the input device upon detection of a selection of any suitable and/or combinations of icons.

Also upon detection of, for example, a selection of two or more applications and application sub-parts (in alternate embodiments any number of applications and/or application sub-parts may be selected), the process module 122 may be configured to launch or otherwise activate the corresponding applications and application sub-parts (FIG. 4, Block 430). In one aspect of the disclosed embodiments the launching of the corresponding applications and application sub-parts may occur substantially simultaneously with the unlocking of the input device 104. In alternate embodiments launching of the corresponding applications and application sub-parts may occur at a predetermined time after the input device 104 is unlocked or at any other suitable time after unlocking the input device 104. As a non-limiting example, the selection of the message application icon 360 and the new icon 310 and the detection thereof, causes a launching of the message application such that a new message is presented when the message application is launched.

It is noted that all tasks or combination of tasks pertaining to each of the applications may not be included in the idle screen 300. As such, in another aspect of the disclosed embodiments the device may be unlocked and an application may be started by a detection of a selection of a single icon such as, for example, one of the application icons 320, 350, 360. In this example, the application corresponding to the selected icon may be launched so that a “home” screen of the application (e.g. the initial screen presented by the application which generally gives a user access to all of the features of the application) is presented upon unlocking of the input device 104. In other aspects of the disclosed embodiments, an “unlock” icon 380 may be presented on the idle screen 300. In one example, the unlock icon 380 may be used in conjunction with an application icon so that the input device 104 is unlocked upon detection of a selection (either sequentially or simultaneously) of both the unlock icon and an application icon such that upon unlocking the input device 104 the selected application is launched in a manner similar to that described above. In another example, the input device 104 may be unlocked by detecting a selection of the unlock icon 380 alone such that upon unlocking the input device 104 a home screen of the system 100 is presented on the display 114. The home screen of the system 100 may be for example, a screen that generally provides access to all or most of the applications and features of the system 100.

In another aspect of the disclosed embodiments the process module 122 includes a usage module 138. The usage module 138 may be configured to monitor the usage of the system 100 such as, for example, which applications and/or application sub-parts are used most frequently. The usage module 138 may store data relating to the usage of the applications and application sub-parts in, for example, storage device 182. The process module 122 (or idle screen module 140) may be configured to access and analyze the usage data such that, for example, icons corresponding to the most frequently used applications and/or application sub-parts are presented on an idle screen, such as idle screen 300. In other aspects of the disclosed embodiments, the process module 122 (or idle screen module 140) may be configured to allow contents of the idle screen to be defined or specified by a user through any suitable menu such as, for example, menu 124. In still another aspect of the disclosed embodiments, the contents of the idle screen may depend on an application that is running on the system 100. For exemplary purposes only, a music player may be running on the system 100 such that the contents of the idle screen correspond to application sub-parts of the music player. For example, the idle screen may include icons corresponding to controls such as play, stop, pause, next, previous, track, album, or any other suitable controls for using the music player.

Referring to FIG. 1, in one embodiment as described above, the user interface of the disclosed embodiments can be implemented on or in a device that includes a touch screen display 112, proximity screen device or other graphical user interface. In one embodiment, the display 112 can be integral to the system 100. In alternate embodiments the display may be a peripheral display connected or coupled to the system 100. A pointing device, such as for example, a stylus, pen or simply the user's finger may be used with the display 112. In alternate embodiments any suitable pointing device may be used. The display can also include or comprise, for example, a flat display that is typically made of a liquid crystal display (LCD) with optional back lighting, such as a thin film transistor (TFT) matrix capable of displaying color images. Although display 114 of FIG. 1 is shown as being associated with output device 106, in one embodiment, displays 112 and 114 form a single display unit.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information, such as text, on the screen of the device. Thus, the above noted terms are intended to include that a user only needs to be within the proximity of the device to carry out the desired function. It should also be understood that arrow keys on a keyboard, mouse style devices and other cursors could be used as the pointing device and to move a pointer.

Similarly, the scope of the intended devices is not limited to single-touch or multi-touch contact devices. Non-touch devices are also intended to be encompassed by the disclosed embodiments. Non-touch devices include, but are not limited to, devices without touch or proximity displays or screens, where navigation on the display and menus of the various applications is performed through, for example, keys 110 of the system or through voice commands via voice recognition features of the system.

Some examples of devices on which aspects of the disclosed embodiments can be practiced are illustrated with respect to FIGS. 5A-5B. The devices are merely exemplary and are not intended to encompass all possible devices or all aspects of devices on which the disclosed embodiments can be practiced. The aspects of the disclosed embodiments can rely on very basic capabilities of devices and their user interfaces. Buttons or key inputs can be used for selecting and controlling the functions and commands described herein, and a scroll key function can be used to move to and select item(s), such as text.

As shown in FIG. 5A, the device 500, which in one embodiment comprises a mobile communication device or terminal may have a keypad 510 as an input device and a display 520 for an output device. In one embodiment, the keypad 510 forms part of the display unit 520. The keypad 510 may include any suitable user input devices such as, for example, a multi-function/scroll key 530, soft keys 531, 532, a call key 533, an end call key 534 and a QWERTY keyboard 535 including numerical input. In other examples, the keypad may include alphanumeric keys. The display 520 may be any suitable display such as, for example, a touch screen display or graphical user interface. The display may be integral to the device 500 or the display may be a peripheral display connected or coupled to the device 500. A pointing device such as, for example, a stylus, pen or simply the user's finger may be used in conjunction with the display 520 for cursor movement, menu selection, text selection and other input and commands. In alternate embodiments, any suitable pointing or touch device may be used. In other alternate embodiments, the display may be a conventional display. The device 500 may also include other suitable features such as, for example, a loud speaker, headset, tactile feedback devices or connectivity port. The mobile communications device may have at least one processor 518 connected or coupled to the display for processing user inputs and displaying information and links on the display 520, as well as carrying out the aspects of the embodiments described herein. At least one memory device 502 may be connected or coupled to the processor 518 for storing any suitable information, data, settings and/or applications associated with the mobile communications device 500.

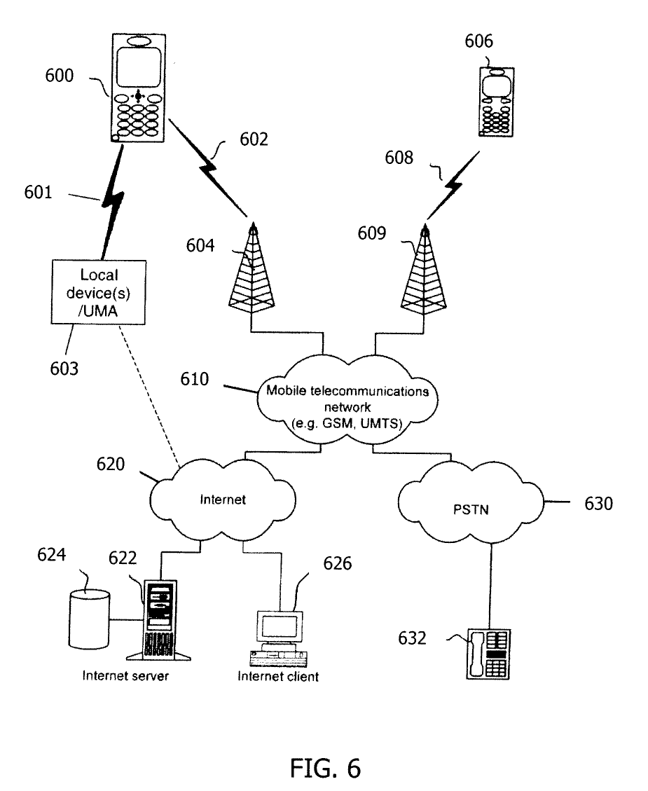

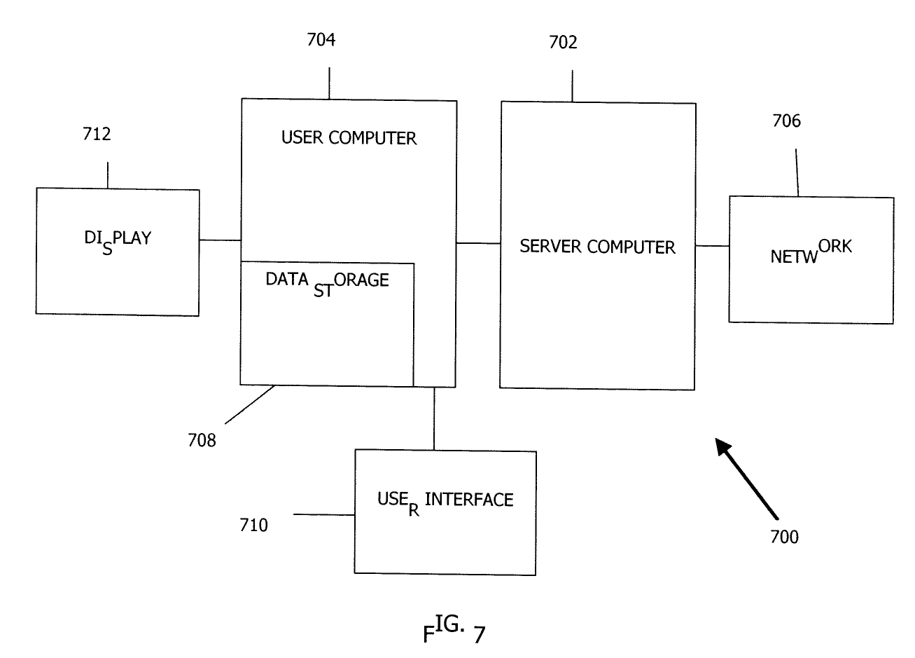

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 600 and other devices, such as another mobile terminal 606, a line telephone 632, a computing device 626 and/or an internet server 622.

In one embodiment the system is configured to enable any one or combination of chat messaging, instant messaging, text messaging and/or electronic mail, and the text-to-speech conversion process described herein can be applied to the computer understandable text in such messages and/or communications. It is to be noted that for different embodiments of the mobile device or terminal 600, and in different situations, some of the telecommunications services indicated above may or may not be available. The aspects of the disclosed embodiments are not limited to any particular set of services or communication system, protocol or language in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. An Internet server 622 has data storage 624 and is connected to the wide area network 620, as is an Internet client 626. The server 622 may host a worldwide web/wireless application protocol server capable of serving worldwide web/wireless application protocol content to the mobile terminal 600.

A public switched telephone network (PSTN) 630 may be connected to the mobile telecommunications network 610 in a familiar manner. Various telephone terminals, including the stationary telephone 632, may be connected to the public switched telephone network 630.

The mobile terminal 600 is also capable of communicating locally via a local link 601 to one or more local devices 603. The local links 601 may be any suitable type of link or piconet with a limited range, such as for example Bluetooth™, a Universal Serial Bus (USB) link, a wireless Universal Serial Bus (WUSB) link, an IEEE 802.11 wireless local area network (WLAN) link, an RS-232 serial link, etc. The local devices 603 can, for example, be various sensors that can communicate measurement values or other signals to the mobile terminal 600 over the local link 601. The above examples are not intended to be limiting, and any suitable type of link or short range communication protocol may be utilized. The local devices 603 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)).

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 550 illustrated in FIG. 5B. The personal digital assistant 550 may have a keypad 552, cursor control 554, a touch screen display 556, and a pointing device 560 for use on the touch screen display 556. In still other alternate embodiments, the device may be a personal computer, a tablet computer, touch pad device, Internet tablet, a laptop or desktop computer, a mobile terminal, a cellular/mobile phone, a multimedia device, a personal communicator or any other suitable device capable of containing for example a display 114 shown in FIG. 1, and supported electronics such as the processor 518 and memory 502 of FIG. 5A. In one embodiment, these devices will be Internet enabled.

The user interface 102 of FIG. 1 can also include menu systems 124 coupled to the processing module 122 for allowing user input and commands. The processing module 122 provides for the control of certain processes of the system 100 including, but not limited to, the controls for selecting files and objects, establishing and selecting search and relationship criteria, navigating among the search results, identifying computer readable text, and detecting commands for customizing (e.g. user defined) the idle screen of the system 100. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications, start and stop points and state change requests. Depending on the inputs, the process module 122 interprets the commands and directs the applications process control 132 to execute the commands accordingly in conjunction with the other modules.

The disclosed embodiments may also include software and computer programs incorporating the process steps and instructions described above. In one embodiment, the programs incorporating the process steps described herein can be executed in one or more computers. FIG. 7 is a block diagram of one embodiment of a typical apparatus 700 incorporating features that may be used to practice aspects of the invention. The apparatus 700 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 700. The memory can be directly coupled or wirelessly coupled to the apparatus 700. As shown, a computer system 702 may be linked to another computer system 704, such that the computers 702 and 704 are capable of sending information to each other and receiving information from each other. In one embodiment, computer system 702 could include a server computer adapted to communicate with a network 706. Alternatively, where only one computer system is used, such as computer 704, computer 704 will be configured to communicate with and interact with the network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or other suitable connection or line, communication channel or link. In one embodiment, the communication channel comprises a suitable broad-band communication channel. Computers 702 and 704 are generally adapted to utilize program storage devices embodying machine-readable program source code, which is adapted to cause the computers 702 and 704 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 704 may include a data storage device 708 on its program storage device for the storage of information and data. The computer program or software incorporating the processes and method steps incorporating aspects of the disclosed embodiments may be stored in one or more computers 702 and 704 on an otherwise conventional program storage device. In one embodiment, computers 702 and 704 may include a user interface 710, and/or a display interface 712 from which aspects of the invention can be accessed. The user interface 710 and the display interface 712, which in one embodiment can comprise a single interface, can be adapted to allow the input of queries and commands to the system, as well as present the results of the commands and queries, as described with reference to FIG. 1, for example.

The aspects of the disclosed embodiments provide substantially direct access to the applications and/or application sub-parts from an idle screen of a system 100 that would otherwise be activated through, for example, a grid of applications that is presented to a user after unlocking a device. In accordance with aspects of the disclosed embodiments, the applications and/or application sub-parts are accessed from the idle screen substantially at the same time an input device 104 is unlocked such that unlocking the input device 104 effectively activates or launches the applications and/or application sub-parts.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
selecting one or more keys on an apparatus where selecting the one or more keys unlock an input device of the apparatus and activates an application of the apparatus substantially at the same time.

2. The method of claim 1, wherein activating the application includes activating a sub-part of the application.

3. The method of claim 1, further comprising presenting the one or more keys on a display of the apparatus, where the one or more keys correspond to at least one of applications or application sub-parts stored in or accessible by the apparatus.

4. The method of claim 3, further comprising monitoring a usage of the apparatus wherein the icons presented on the display depend on a usage of their respective applications.

5. The method of claim 3, further comprising presenting the icons on the display dependent upon an application actively running on the apparatus.

6. The method of claim 1, further comprising that the one or more keys comprise hard keys of the apparatus, where the one or more keys correspond to at least one of applications or application sub-parts stored in or accessible by the apparatus.

7. The method of claim 1, further comprising presenting the one or more keys in an idle screen of the apparatus.

8. The method of claim 1, wherein selecting the one or more keys comprises selecting the one or more keys in a sequence or substantially simultaneously.

9. An apparatus comprising:
an input device having at least one key corresponding to a respective application of the apparatus; and
a processor connected to the input device, the processor being configured to,
detect a selection of the at least one key,
unlock the input device in response to the detected selection, and
activate a respective application corresponding to the selected at least one key,
wherein the input device is unlocked substantially simultaneously with the activation of the respective application.

10. The apparatus of claim 9, further comprising a display connected to the processor wherein the at least one key comprises at least two icons presented on the display.

11. The apparatus of claim 10, wherein the processor is configured to monitor a usage of apparatus, wherein the at least two icons are presented on the display depending on an amount of usage of their respective applications.

12. The apparatus of claim 10, wherein the at least two icons presented on the display depend on an application actively running on the apparatus.

13. The apparatus of claim 9, wherein the at least one key comprises a first key corresponding to the respective application and a second key corresponding to a sub-part of the application, the processor being further configured to activate the sub-part of the application upon detection of a selection of the first and second keys.

14. The apparatus of claim 13, wherein the processor is further configured to detect a sequential selection or a simultaneous selection of the first and second keys.

15. The apparatus of claim 9, wherein the at least one key comprises hard keys of the apparatus, each of the hard keys correspond to at least one of applications or application sub-parts stored in or accessible by the apparatus.

16. A computer readable storage medium having computer readable code means embodied therein for causing a computer to unlock an input device and activate an application of the computer, the computer readable code means in the computer useable medium comprising:
computer readable program code means for causing a computer to detect a selection of one or more keys on an input device of the computer; and
computer readable program code means for causing a computer to unlock the input device and activate an application of the apparatus substantially at the same time in response to detecting the selection of the one or more keys.

17. The computer readable storage medium of claim 16, wherein activation of the application includes activation of a sub-part of the application.

18. The computer readable storage medium of claim 16, further comprising computer readable program code means for causing a computer to present the one or more keys are icons on a display of the computer, where the one or more keys correspond to at least one of applications or application sub-parts stored in or accessible by the computer.

19. The computer readable storage medium of claim 16, wherein the one or more keys comprise hard keys of the computer, where the one or more keys correspond to at least one of applications or application sub-parts stored in or accessible by the apparatus.

20. The computer readable storage medium of claim 16, wherein selecting the one or more keys comprises selecting the one or more keys in a sequence or substantially simultaneously.

21. A user interface comprising:
an input device having at least one key corresponding to a respective application of the apparatus; and
a processor connected to the input device, the processor being configured to,
detect a selection of the at least one key,
unlock the input device in response to the detected selection, and
activate a respective application corresponding to the selected at least one key,
wherein the input device is unlocked substantially simultaneously with the activation of the respective application.

22. The user interface of claim 21, further comprising a display connected to the processor wherein the at least one key comprises at least a first and a second icon presented on the display, the first icon corresponding to the respective application and the second icon corresponding to a sub-part of the application, the processor being further configured to activate the sub-part of the application upon detection of a selection of the first and second icons.

23. The user interface of claim 22, wherein the processor is further configured to detect a sequential selection or a simultaneous selection of the first and second icons.

24. The user interface of claim 21, wherein activation of the respective application includes activating a sub-part of the respective application.
